(19) United States
(12) Patent Application Publication
(10) Pub. No.: US 2018/0338610 A1
(43) Pub. Date: Nov. 29, 2018

(54) HOUSING FOR SAFETY EQUIPMENT

(71) Applicant: David A. Bergman, Santa Ana, CA (US)

(72) Inventor: David A. Bergman, Santa Ana, CA (US)

(21) Appl. No.: 15/988,963

(22) Filed: May 24, 2018

Related U.S. Application Data
(60) Provisional application No. 62/511,834, filed on May 26, 2017.

(51) Int. Cl. A47B 81/00; A47B 96/00

(52) U.S. Cl. CPC A47B 81/00; E05B 65/00; A47B 96/00

(57) ABSTRACT

Described herein generally are housings used to store safety equipment. In some embodiments, the housings can store fire extinguishers, and comply with the American Disabilities Act guidelines.

### CROSS REFERENCE TO RELATED APPLICATIONS

This application claims the benefit of U.S. provisional patent application Ser. No. 62/511,834, filed May 26, 2017, the entire disclosure of which is incorporated herein by reference.

### FIELD

Housings used to store safety equipment or the like are described herein.

### BACKGROUND

The American Disabilities Act (ADA) provides that any object on a wail cannot protrude by more than four inches. This guideline was enacted to protect blind people and people with impaired/limited vision.

The ADA also provides that mounts such as fire extinguisher hooks be no higher than forty-eight inches. Often, retailers fail to comply with this guideline because of incidents with patron's shopping carts colliding with the fire extinguisher and/or hooks.

There is a need in the art for housings which can store safety equipment in compliance with the ADA.

### SUMMARY

Described herein generally are housings used to store safety equipment. In some embodiments, the housings can store fire extinguishers, and comply with ADA guidelines.

In some embodiments, a housing is described herein that includes a top edge, a bottom edge, a first side edge, a second side edge, a front surface, and a back surface.

In some embodiments, the housing is rectangular. In other embodiments, the housing is square.

In some embodiments, the housing can have rounded edges.

In other embodiments, the front surface of the housing can include a hinge on one end and an opening mechanism on the opposite end of the front surface. The opening mechanism can be a latch. Thus, when the latch is pulled on the front surface of the housing, a door can open to reveal the interior of the enclosure.

In some embodiments, the front surface of the housing can include a panel. In other embodiments, the panel can further include a window.

In some embodiments, the front surface can further include a locking mechanism to keep the housing secure/locked.

In some embodiments, the housing can have a white finish. In other embodiments, the housing can have a clear acrylic glazing. In some embodiments, the housing can be made of steel. In other embodiments, the housing can have a red finish.

In other embodiments, the housing can be about four inches deep. In some embodiments, the housing can protrude no more than about four inches from a surface on which it is mounted.

### DRAWINGS

FIG. 1 illustrates a perspective view of a housing to store safety equipment as described herein.

FIG. 2 illustrates an interior view of a housing described herein.

FIG. 3 illustrates a top view of a housing described herein.

FIG. 4 Illustrates a front view of a housing described herein.

FIG. 5 illustrates a side edge of a housing described herein.

### DETAILED DESCRIPTION

Described herein generally are housings to store safety equipment. In some embodiments, the housings can be used to store fire extinguishers. In other embodiments, the housings are complaint with the ADA guidelines and can protrude no more than four inches from the surface on which they are mounted.

In some embodiments, a housing is described that includes a top edge, a bottom edge, a first side edge, a second side edge, a front surface, and a back surface. The top edge, bottom edge, first side edge, second side edge, front surface, and back surface are welded/assembled to form an enclosure that can be about four inches deep. Thus, the housing protrudes no more than about four inches from a surface on which it is mounted.

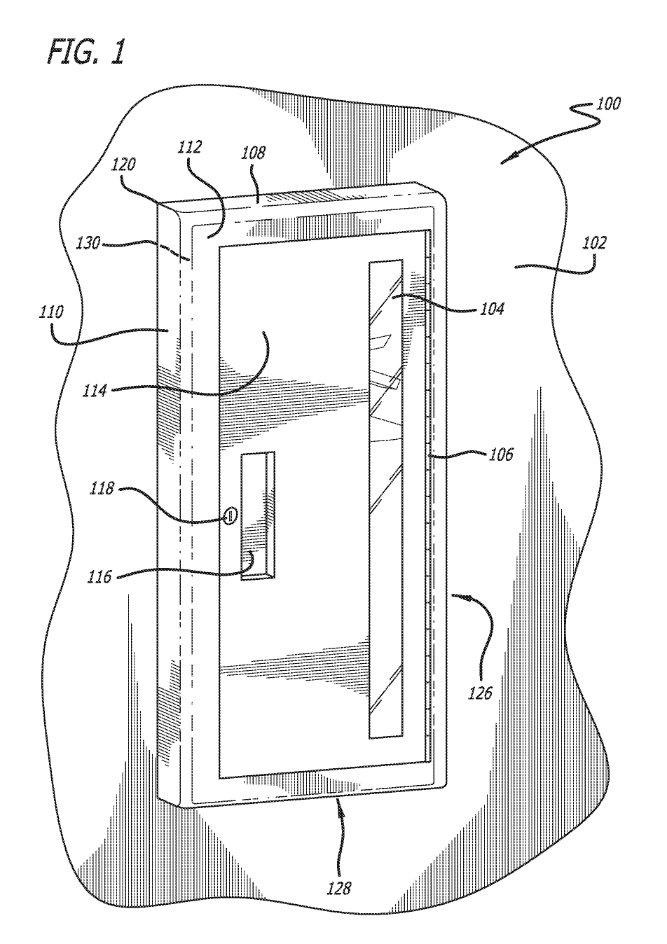

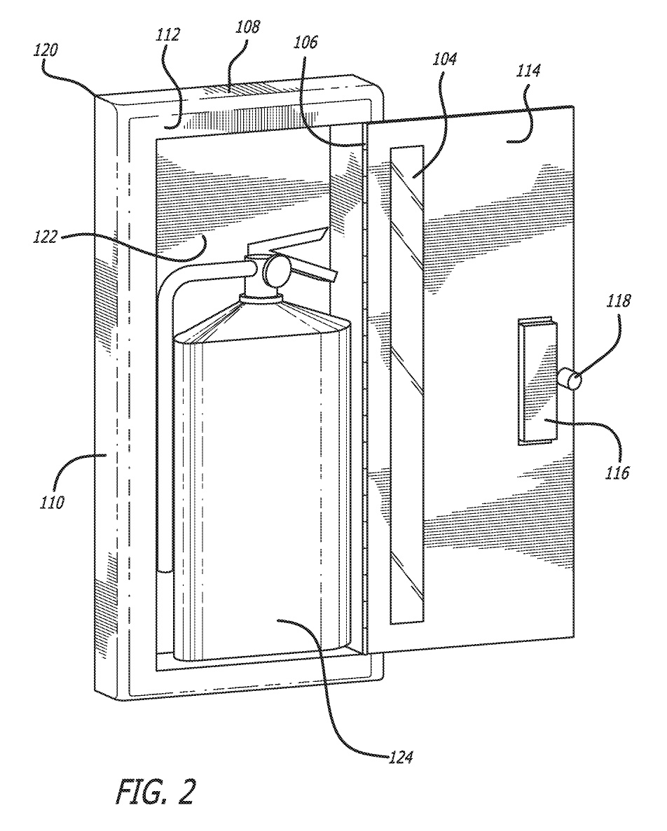

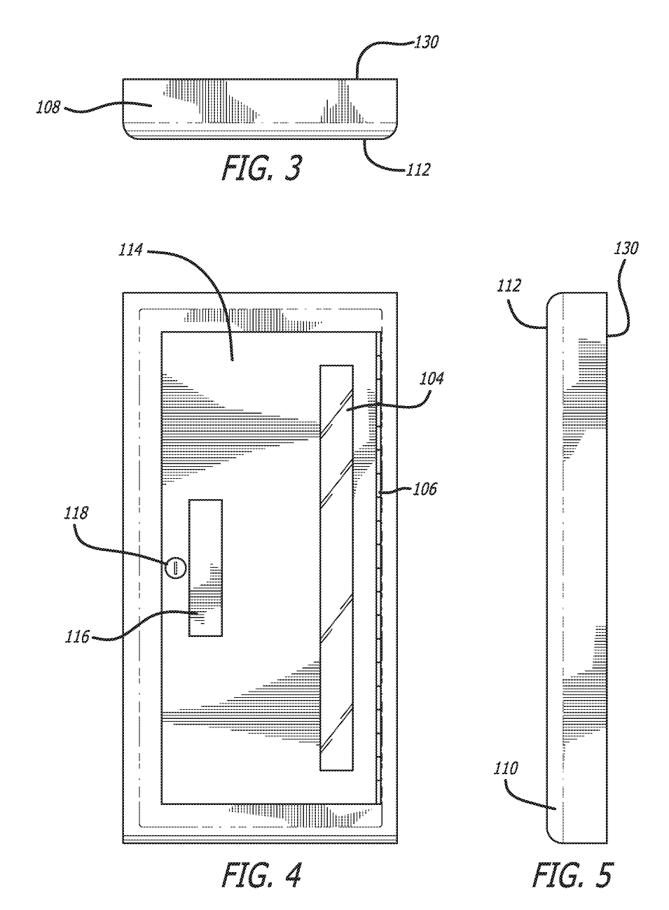

In one embodiment, housing 100 is illustrated in FIGS. 1-5. Housing 100 includes front surface 112, top edge 108, bottom edge 128, first side edge 110, second side edge 126, and back surface 130. Housing 100 can also include rolled trims 120, locking mechanism 118, latch 116, window 104, hinge 106, and panel 114. Further, housing 100 can be mounted on a surface such as wall 102.

In some embodiments, housing 100 can be about 1 inch in depth, about 1.5 inches in depth, about 2.0 inches in depth, about 2.5 inches in depth, about 3.0 inches in depth, about 3.5 inches in depth, about 4.0 inches in depth, about 4.5 inches in depth, or about 5.0 inches in depth.

In other embodiments, housing 100 can be 1 inch in depth, 1.5 inches in depth, 2.0 inches in depth, 2.5 inches in depth, 3.0 inches in depth, 3.5 inches in depth, 4.0 inches in depth, 4.5 inches in depth, or 5.0 inches in depth.

In some embodiments, housing 100 can be less than 1 inch in depth, less than 1.5 inches in depth, less than 2.0 inches in depth, less than 2.5 inches in depth, less than 3.0 inches in depth, less than 3.5 inches in depth, less than 4.0 inches in depth, less than 4.5 inches in depth, or less than 5.0 inches in depth.

In other embodiments, housing 100 can be more than 1 inch in depth, more than inches in depth, more than 2.0 inches in depth, more than 2.5 inches in depth, more than 3.0 inches in depth, more than 3.5 inches in depth, more than 4.0 inches in depth, more than 4.5 inches in depth, or more than 5.0 inches in depth.

In some embodiments, housing 100 can be between about 0.5 to about 1.5 inches in depth, between about 0.75 to about 1.75 inches in depth, between about 1.5 to about 2.5 inches in depth, between about 1.25 to about 2.5 inches in depth, between about 3.0 to about 4.0 inches in depth, between about 1.75 to about 3.00 inches in depth, or between about 3.5 to about 5.0 inches in depth.

Housing 100 can be rectangular, square, trapezoidal, or any other rectilinear shape. In one embodiment, the housing is rectangular. The edges of housing 100 can be round, square, flat, or a rolled trim. In some embodiments, the edge design can be full radius, half radius, full bevel, half bevel, or square. In some embodiments, the edges are round. In other embodiments, the edges of the housing are rolled trim 120.

In some embodiments, the width of a first side edge or a second side edge of housing 100 can be about 1 inch, about 1.5 inches, about 2.0 inches, about 2.5 inches, about 3.0 inches, about 3.5 inches, about 4.0 inches, about 4.5 inches, about 5.0 inches, 1 inch, 1.5 inches, 2.0 inches, 2.5 inches, 3.0 inches, 3.5 inches, 4.0 inches, 4.5 inches, 5.0 inches, less than 1 inch, less than 1.5 inches, less than 2.0 inches, less than 2.5 inches, less than 3.0 inches, less than 3.5 inches, less than 4.0 inches, less than 4.5 inches, less than 5.0 inches, more than 1 inch, more than 1.5 inches, more than 2.0 inches, more than 2.5 inches, more than 3.0 inches, more than 3.5 inches, more than 4.0 inches, more than 4.5 inches, more than 5.0 inches, between about 0.5 to about 1.5 inches, between about 0.75 to about 1.75 inches, between about 1.5 to about 2.5 inches, between about 1.25 to about 2.5 inches, between about 3.0 to about 4.0 inches, between about 1.75 to about 3.00 inches, or between about 3.5 to about 5.0 inches. In other embodiments the width of a first side edge or a second side edge of housing 100 can be about 4 inches.

In some embodiments, a first side edge or a second side edge of housing 100 can have a frame length of between about 0.1 inches to about 5 inches, between about 5 inches to about 10 inches, between about 5 inches to about 15 inches, between about 10 inches to about 20 inches, between about 15 inches to about 20 inches, between about 15 inches to about 25 inches, between about 20 inches to about 30 inches, between about 25 inches to about 35 inches, between about 30 inches to about 40 inches, between about 35 inches to about 45 inches, between about 40 inches to about 50 inches, between about 45 to 55 inches, between about 50 inches to about 60 inches, between about 55 inches to 65 inches, between about 60 to 70 inches, between about 65 inches to about 75 inches, between about 80 inches to about 90 inches, between about 75 inches to about 85 inches, between about 90 to inches to about 100 inches, between about 85 inches to about 95 inches, between about 100 inches to 110 inches. In other embodiments, a first side edge or second side edge 110 of housing 100 can have a frame length of about 30⅜ inches.

In other embodiments, back surface 130 can be 20 gauge. The back surface can have a frame length between about 0.1 inches to about 5 inches, between about 5 inches to about 10 inches, between about 5 inches to about 15 inches, between about 10 inches to about 20 inches, between about 15 inches to about 20 inches, between about 15 inches to about 25 inches, between about 20 inches to about 30 inches, between about 25 inches to about 35 inches, between about 30 inches to about 40 inches, between about 35 inches to about 45 inches, between about 40 inches to about 50 inches, between about 45 to 55 inches, between about 50 inches to about 60 inches. In some embodiments, the back surface is 15⅜ inches in frame length.

In some embodiments, the front surface of the housing can include a hinge at one end and an opening mechanism at the other end. The hinge can be continuous. In other embodiments, the hinge can comprise of two, three, four, five, six, seven, eight, or more hinges. The opening mechanism can be a latch, a pull open lever, a handle, a door handle, or the like. In some embodiments, the opening mechanism can be a latch, such as latch 116. In other embodiments, front surface 112 of housing 100 can include hinge 106 on one end and latch 116 on the opposite end. When latch 116 is pulled on, front surface 112 can swing open to reveal interior 122 of housing 100. In some embodiments, the front surface can be a 20 gauge vertical duo door. The housing can be used to store safety equipment. Safety equipment can include, but is not limited to, fire extinguishers, first aid kits, defibrillators, fire blankets, axes, and the like. In other embodiments, the housing is used to store a fire extinguisher.

In other embodiments, the housing can comprise an enclosure including a mechanism to secure a piece of safety equipment. The enclosure can be about 1 inch in depth, about 1.5 inches in depth, about 2.0 inches in depth, about 2.5 inches in depth, about 3.0 inches in depth, about 3.5 inches in depth, about 4.0 inches in depth, about 4.5 inches in depth, about 5.0 inches in depth, 1 inch in depth, 1.5 inches in depth, 2.0 inches in depth, 2.5 inches in depth, 3.0 inches in depth, 3.5 inches in depth, 4.0 inches in depth, 4.5 inches in depth, 5.0 inches in depth, less than 1 inch in depth, less than 1.5 inches in depth, less than 2.0 inches in depth, less than 2.5 inches in depth, less than 3.0 inches in depth, less than 3.5 inches in depth, less than 4.0 inches in depth, less than 4.5 inches in depth, less than 5.0 inches in depth, more than 1 inch in depth, more than 1.5 inches in depth, more than 2.0 inches in depth, more than 2.5 inches in depth, more than 3.0 inches in depth, more than 3.5 inches in depth, more than 4.0 inches in depth, more than 4.5 inches in depth, more than 5.0 inches in depth, between about 0.5 to about 1.5 inches in depth, between about 0.75 to about 1.75 inches in depth, between about 1.5 to about 2.5 inches in depth, between about 1.25 to about 2.5 inches in depth, between about 3.0 to about 4.0 inches in depth, between about 1.75 to about 3.00 inches in depth, or between about 3.5 to about 5.0 inches in depth.

In some embodiments, the enclosure can include a mechanism to secure a fire extinguisher where the enclosure is not more than four inches deep. The securing mechanism can be a hook, hooks, a brace, braces, or the like, or a combination thereof. The securing mechanism can be on the back surface of the housing, the bottom edge of the housing, the top edge of the housing, the first side edge of the housing, the second side edge of the housing, or on the inner side of the front surface of the housing. In some embodiments, the housing can have no back surface and the securing mechanism can be directly placed on the surface on which the housing is mounted.

In other embodiments, the housing can be mounted to a surface by welding, screws, brackets, braces, or the like, or a combination thereof. In some embodiments, the housing can be recessed into a surface.

In some embodiments, housing 100 can be used to store a fire extinguisher, such as fire extinguisher 124. In other embodiments, the housing can be used to store Oval® fire extinguishers, including but not limited to, model 10HABC, model 10JABC, or model 10HPKP. In some embodiments, the fire extinguisher can be about 1 lb, about 2 lbs, about 3 lbs, about 4 lbs, about 5 lbs, about 6 lbs, about 7 lbs, about 8 lbs, about 9 lbs, about 10 lbs, about 11 lbs, about 12 lbs, about 13 lbs, about 14 lbs, or about 15 lbs. In other embodiments, the fire extinguisher is about 10 lbs.

In other embodiments, the housing can be used to store Orbit® fire extinguishers. In some embodiments, the housing can be used to store more than one fire extinguisher. Two or more fire extinguishers can be stored in the housing. In some embodiments, the housing can store a fire extinguisher and other safety equipment such as, but not limited to, a first aid kit. In other embodiments two or three fire extinguishers can be stored in the housing which are interconnected to fit the housing.

In some embodiments, front surface 112 of housing 100 can include panel 114. In other embodiments, front surface 112 of housing 100 can include panel 114 which further includes window 104. Window 104 can partially or substantially cover the front surface of housing 100. The window can cover about 1%, about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or about 100% of the front surface of the housing. The window can be flat or have a bubble shape. The window can be composed of glass, breakable glass, tempered safety glass, plastic, or the like, or a combination thereof. Also, the window can be composed of any see-through material which reveals the interior of the housing. In other embodiments, the window can be full break glass.

In other embodiments, the front surface of the housing can be a vertical duo (VD) door, a full glass door, a horizontal duo glass panel, or a solid door. In some embodiments, the solid door has glazing. In other embodiments, the solid door does not have glazing. The vertical duo door can be a door style with a narrow class panel.

In some embodiments, the front surface of the housing can be a 20 gauge VD door with a window that covers more than 50% of the front surface of housing. In other embodiments, the front surface of the housing can be a 20 gauge VD door with a window that covers less than 50% of the front surface of housing.

In some embodiments, front surface 114 can include latch 116 to pull open front surface 114 of housing 100 thereby exposing interior 122 of housing 100. In other embodiments, the housing can include locking mechanism. The locking mechanism can be a keyhole, a furniture lock, a padlock, a cam lock, a deadbolt lock, a combination lock, a gang lock, a glass door lock, a bypass sliding lock, an electronic lock, a magnetic catch, a friction catch, a touch catch, or a combination thereof. The front surface of the housing can further include safety warnings or labels. In some embodiments, the front surface of the housing can include a latch with the words pull to open. In other embodiments, the front surface of the housing can include both a latch and a locking mechanism, such as a keyhole.

Housing 100 can also include a back panel. The back panel can be 20 gauge. The back panel can have a frame length between about 0.1 inches to about 5 inches, between about 5 inches to about 10 inches, between about 5 inches to about 15 inches, between about 10 inches to about 20 inches, between about 15 inches to about 20 inches, between about 15 inches to about 25 inches, between about 20 inches to about 30 inches, between about 25 inches to about 35 inches, between about 30 inches to about 40 inches, between about 35 inches to about 45 inches, between about 40 inches to about 50 inches, between about 45 to 55 inches, between about 50 inches to about 60 inches. In some embodiments, the back panel is 15⅜ inches in frame length.

In some embodiments, the housing can have a white finish, a yellow finish, a red finish, or any other color finish. In other embodiments the housing can include a clear acrylic glazing. The housing can be made of steel, aluminum, stainless steel, plastic, fiberglass, wood, or a combination thereof. In one embodiment, the housing is made of steel.

In some embodiments, the enclosure of the housing can include a light. The light can be a LED light, a fluorescent light, micro fluorescent lights, strip lights, puck lights, or the like, or a combination thereof. In other embodiments, the light can be battery operated in case of an emergency, such as a power outage failure.

The preceding disclosures are illustrative embodiments. It should be appreciated by those of skill in the art that the devices, techniques and methods disclosed herein elucidate representative embodiments that function well in the practice of the present disclosure. However, those of skill in the art should, in light of the present disclosure, appreciate that many changes can be made in the specific embodiments that are disclosed and still obtain a like or similar result without departing from the spirit and scope of the invention.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a” and “an” and “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided herein is intended merely to better illuminate the invention and does not pose a limitation on the scope of the invention otherwise claimed. No language in the specification should be construed as indicating any non-claimed element essential to the practice of the invention,

The use of the term “or” in the claims is used to mean “and/or” unless explicitly indicated to refer to alternatives only or the alternatives are mutually exclusive, although the disclosure supports a definition that refers to only alternatives and “and/or.”

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is herein deemed to contain the group as modified thus fulfilling the written description of all Markush groups used in the appended claims.

Preferred embodiments of this invention are described herein, including the best mode known to the inventors for carrying out the invention. Of course, variations on those preferred embodiments will become apparent to those of ordinary skill in the art upon reading the foregoing description. The inventor expects those of ordinary skill in the art to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context,

Specific embodiments disclosed herein may be further limited in the claims using consisting of or consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of the invention so claimed are inherently or expressly described and enabled herein.

Further, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

We claim:

1. A housing comprising:
a top edge, a bottom edge, a front surface, a back surface, a first side edge, and a second side edge thereby forming an enclosure which is about four inches deep to store safety equipment.

2. The housing of claim 1, wherein the safety equipment is a fire extinguisher, a defibrillator, a first aid kit, an axe, a fire blanket, or a combination therefore.

3. The housing of claim 2, wherein the safety equipment is a fire extinguisher.

4. The housing of claim 1, wherein the front surface further comprises a latch.

5. The housing of claim 1, wherein the front surface further comprises a keyhole.

6. The housing of claim 5, wherein the front surface further comprises a latch and a keyhole.

7. The housing of claim 6, wherein the housing is mounted on a surface.

8. The housing of claim 7, wherein the surface is a wall.

9. The housing of claim 8, wherein the front surface further comprises a panel.

10. The housing of claim 9, wherein the panel further comprises a window.

11. The housing of claim 10, wherein the window substantially covers the front surface of the housing.

12. The housing of claim 11, wherein the window covers about half of the front surface of the housing.

13. A housing comprising:
an enclosure including a mechanism to secure a piece of safety equipment;
wherein the enclosure is no more than four inches deep.

14. The housing of claim 13, wherein the safety equipment is a fire extinguisher.

15. The housing of claim 14, wherein the front surface further comprises a latch and a keyhole.

16. The housing of claim 15, wherein the front surface further comprises a panel.

17. The housing of claim 16, wherein the panel further comprises a window.

18. The housing of claim 17, wherein the window substantially covers the front surface of the housing.

19. The housing of claim 18, wherein the window covers about half of the front surface of the housing.

20. The housing of claim 19, wherein the mechanism is a hook, hooks, a brace, braces, or the like, or a combination thereof.
